(19) United States
(12) Patent Application Publication
(10) Pub. No.: US 2014/0276294 A1
(43) Pub. Date: Sep. 18, 2014

(54) Multiple Bladder Deep Vein Thrombosis Prevention Garment

(71) Applicant: Compression Therapy Concepts, Inc., Eatontown, NJ (US)

(72) Inventors: Orlando Mansur, Jr., Eatontown, NJ (US); Leonard Nass, Eatontown, NJ (US)

(73) Assignee: Compression Therapy Concepts, Inc., Eatontown, NJ (US)

(21) Appl. No.: 14/217,068

(22) Filed: Mar. 17, 2014

Related U.S. Application Data
(60) Provisional application No. 61/786,379, filed on Mar. 15, 2013.

(51) Int. Cl. A61H 9/00; A61H 1/00

(52) U.S. Cl. CPC A61H 9/0078; A61H 1/008
USPC 601/152; 601/148

(57) ABSTRACT

A deep vein thrombosis prevention garment includes a central panel formed with sequentially filled inner, intermediate and outer air chambers separated from each other with pressure resistive valves, a left side panel, and a right side panel formed with a number of attachment straps having an integral fastener. The inner air chamber receives air from a pump. When the air within the inner air chamber reaches a predetermined air pressure, the pressure resistive valve between the inner air chamber and the intermediate air chamber allows air to pass from the inner air chamber to an intermediate air chamber. When the air within the intermediate air chamber reaches a predetermined air pressure, the pressure resistive valve between the intermediate air chamber and the outer air chamber allows air to pass from the intermediate chamber to the outer air chamber. A membrane panel allows air to escape the sequentially filled air chambers.

### RELATED APPLICATION

This application claims the benefit of priority to U.S. Provisional Application No. 61/786,379, filed on Mar. 15, 2013, entitled “Multiple Bladder Deep Vein Thrombosis Prevention Garment”, and currently co-pending.

### FIELD OF THE INVENTION

The present invention relates generally to medical and therapy devices. The present invention is more particularly useful as a compression garment for use in the prevention of deep vein thrombosis. The present invention is particularly useful to prevent deep vein thrombosis during periods of low or no activity by continually circulating blood through a patient's extremities.

### BACKGROUND OF THE INVENTION

Deep Vein Thrombosis, or “DVT”, is a blood clot (“thrombus”) that forms in a vein deep in the body. A thrombus occurs when blood thickens and clumps together. Most of these thrombi occur in the lower leg or thigh; however, they can also occur in other parts of the body. Thrombi located in the thigh are more likely to break off and cause a pulmonary embolism (“PE”) that clots in the lower leg or other parts of the body. The clots that form close to the skin usually cannot break off and cause a PE due to their reduced size and the reduced pressures exerted on them.

A DVT, or a portion of it, can break off and travel through the bloodstream where it can enter the lung and block blood flow. This condition is called a pulmonary embolism, which is considered to be very serious due to its likelihood of causing damage to the lungs and other organs, and quite possibly leading to death. This condition affects more than 2.5 million Americans each year and is associated with an estimated 50,000 to 200,000 deaths annually.

The venous system is designed to allow for the return of blood to the right side of the heart. Veins are not passive tubes through which blood passes, but are a system that uses muscular compressions, gravity, and inter-venous valves to promote and control the flow of blood through them. The valves are located along the entire length of the vein and ensure that blood only flows in one (1) direction, toward the heart. Blood flow may easily pass through the valve in the direction toward the heart, but when pressure is greater above the valve than below, the cusps will come together thereby closing the valve and preventing the further flow of blood to the heart.

The valves consist of two (2) very thin-walled cusps that originate at opposite sides of the vein wall and come together to meet at the midline of the vein. The diameter of the vein is slightly larger just behind a valve where the cusps attach to the vein wall. Due to the larger diameter of the vein and the propensity for blood to collect and stagnate between the valve cusps and the vein wall, thrombi formation in this area is more likely.

The most common causes of DVT are venous stasis, blood vessel wall injury, and hypercoagulability. Venous stasis is the reduction of blood flow, most notably in the areas of venous valves, usually caused by extended periods of inactivity. These periods of inactivity minimize the muscular compressions applied to the veins, and remove the forces used to propel the blood through the veins, accordingly. This reduction in flow allows the blood to collect and congeal, thereby forming a clot. The conditions that contribute to venous stasis include heart disease, obesity, dehydration, pregnancy, a debilitated or bed-ridden state, stroke, and surgery. Stasis has been known to develop with surgical procedures lasting as little as 30 minutes.

Vessel wall injury can disrupt the lining of the vein, thereby removing the natural protections against clotting. The loss of natural protection will increase the chances of clot formation and the subsequent mobilization of the clot that can lead to a PE. Some of the major causes of vessel wall injury are trauma from fractures and burns, infection, punctures of the vein, injection of irritant solutions, susceptibility to DVT, and major surgeries,

Hypercoagulability exists when coagulation outpaces fibrinolysis, which is the body's natural mechanism to inhibit clot formation. When this condition exists, the chances of clot formation, especially in areas of low blood flow, are greatly increased. Some causes of hypercoagulability are trauma, surgery, malignancy, and systemic infection. A typical treatment is the administration of an anti-coagulant such as low-molecular-weight heparin.

It is recognized that clots usually develop first in the calf veins and “grow” in the direction of flow in the vein. The clots usually form behind valve pockets where blood flow is lowest. Once a clot forms, it either enlarges until it is enveloped, which causes the coagulation process to stop, or the clot may develop a “tail” which has a high chance of breaking off and becoming mobile where it can enter the pulmonary system and become lodged in the lungs.

In a patient with DVT, the goals are to minimize the risk of a PE, limit further clots, and facilitate the resolution of existing clots. If a potential clot is suspected or detected, bed rest is usually recommended to allow for the clot to stabilize and adhere to the vein wall, thereby minimizing the chance of the clot becoming mobile such that it can travel to the kings. A more effective preventative measure is ambulation, which is to walk about or move from place to place. Ambulation requires muscle movement. The muscle movement will provide a continuous series of compressions to the veins, thereby facilitating the flow of blood. The continuous flow of blood will reduce or eliminate any areas of stasis so dots do not have a chance to form. For people who are confined to a bed or will be immobile for an extended period of time, leg elevation is recommended. This will promote blood return to the heart and will decrease any existing venous congestion.

Graduated compression stockings have also been used to apply pressure to the veins so as to reduce or minimize any areas of low flow in the vein, while not allowing the collection and coagulation of blood in these low flow areas. The stockings are designed to provide the highest level of compression to the ankle and calf area, with gradually decreasing pressure continuing up the leg. The stockings prevent DVT by augmenting the velocity of venous return from the legs, thereby reducing venous stasis. Typically, stockings are applied before surgery and are worn until the patient is fully able to move on their own. The stockings need to fit properly and be applied correctly. If too tight, they may exert a tourniquet effect, thereby promoting venous stasis, the very problem tying to be prevented. If too loose, the stockings will not provide adequate compression.

Another treatment of DVT involves the use of intermittent pneumatic compression (IPC). IPC can be of benefit to patients deemed to be at risk of deep vein thrombosis during extended periods of inactivity and is an accepted treatment method for preventing blood clots or complications of venous stasis in persons after physical trauma, orthopedic surgery, neurosurgery, or in disabled persons who are unable to walk or mobilize effectively.

An IPC uses an air pump to inflate and deflate airtight sleeves wrapped around the leg. The successive inflation and deflations simulate the series of compressions applied to the veins from muscle contractions, thereby limiting any stasis that can lead to thrombi formation. This technique is also used to stop blood clots from developing during surgeries that will last for an extended period of time. Another version of IPC is the Venous Foot Pump which provides an alternative to the traditional thigh or calf compression device. The foot pump mimics the natural effects of walking and weight-bearing on the circulation in the feet and legs through compressions applied to the foot. PE remains the most common preventable cause of death in hospitalized patients. The deaths are most often a complication resulting from the formation of a DVT and the subsequent PE that may result from it.

In light of the above, it would be advantageous to provide a deep vein thrombosis prevention garment that minimizes the occurrence of deep vein thrombosis formation. It would be further advantageous to provide a deep vein thrombosis prevention garment that allows medical personnel to customize the compression of limbs being treated to optimize treatments for particular patients. It is a further advantage to provide a deep vein thrombosis prevention garment that provides a sequential inflation of pressure-producing chambers with a single air input, which initiates and directs compression of a limb from a point further down the limb (distal) in a direction toward the heart (proximal). It would also be advantageous to provide a deep vein thrombosis prevention garment that is easy to use, relatively easy to manufacture, and comparatively cost efficient.

### SUMMARY OF THE INVENTION

The multiple Bladder deep vein thrombosis prevention garment (hereafter referred to as the “deep vein thrombosis prevention garment”) of the present invention includes a central panel, a left side panel, and a right side panel formed with a number of attachment straps having an integral fastener, such as Velcro® brand hook and loop fasteners. The central panel is formed to have three (3) sequentially filled air chambers separated from each other with a pressure resistive valve. The inner air filled chamber receives air from a pump through a flexible air supply tube.

When the air within the inner air filled chamber reaches a predetermined air pressure, the pressure resistive valve between the inner air filled chamber and the second air filled chamber allows air to pass from the inner air filled chamber to a second air filled chamber. Likewise, when the air within the second air filled chamber reaches a predetermined air pressure, the pressure resistive valve between the second air filled chamber and the third air filled chamber allows air to pass from the second filled chamber to the third air filled chamber.

In the event that pressures within the first, second or third air filled chamber exceed a predetermined maximum, a membrane panel formed in the third air filled chamber allows air to escape the sequentially filled air chambers. The membrane can have a threshold pressure, which prevents air from passing through the membrane until that threshold pressure is exceeded.

The deep vein thrombosis prevention garment of the present invention is worn by a patient on an extremity that is subject to development of thrombosis, particularly deep vein thrombosis, and particularly during surgery or extended periods of inactivity. In use, the deep vein thrombosis prevention garment is wrapped snugly around a patient's leg, for example. Once activated, the pump provides a periodic air supply to the garment through the flexible air supply tube leading to the inner air filled chamber.

As the inner air filled chamber becomes partially inflated, the inner air filled chamber filled with air provides pressure on the leg of the patient to urge blood flow upward through the leg. As this air pressure is maintained through the flexible air supply tube, the inner air filled chamber becomes pressurized to a predetermined pressure, such as 35 mmHg, and air begins to pass through the pressure resistant valve to the second air filled chamber. As the second air filled chamber inflates, it provides additional pressure on the leg of the patient to urge blood flow further upward through the leg in a distal-to-proximal direction,

As the air pressure is continued through the flexible air supply tube, the inner air filled chamber and second air filled chamber become pressurized to a predetermined pressure, and air begins to pass through the pressure resistant valve to the third air filled chamber. As the third air filled chamber inflates, it provides additional pressure on the leg of the patient to urge blood flow even further upward through the leg in a continued distal-to-proximal direction.

The sequential inflation of the inner air filled chamber, second air filled chamber and third air filled chamber creates a peristaltic, progressively distal-to-proximal force on the veins within the limb being treated. Once all three (3) air filled chambers are pressurized to a predetermined pressure, the pressurized air supplied to the flexible air supply tube is discontinued, and all three (3) air filled chambers deflate, returning the deep vein thrombosis prevention garment of the present invention to its fully un-inflated configuration. In this fully un-inflated configuration, blood flows freely through the limb being treated.

The inflation and deflation timing cycle of the deep vein thrombosis prevention garment of the present invention is determined by the pressures being utilized, and the speed by which the air chambers deflate. In order to effectively urge blood flow through deep veins, the timing for the peristaltic effect of the deep vein thrombosis prevention garment of the present invention is approximately twenty (20) seconds per cycle.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a top plan view of the deep vein thrombosis prevention garment of the present invention showing a central panel, a left side panel, and a right side panel formed with a number of attachment straps having an integral fastener, and with the central panel having three sequentially filled air chambers (shown in dashed lines) receiving air from a pump through a flexible air supply tube;

FIG. 2 is a view of the deep vein thrombosis prevention garment being used by a patient for the prevention of deep vein thrombosis, showing a pump supplying pressurized air through a flexible air supply tube;

FIG. 3 is a top plan view of the deep vein thrombosis prevention garment of the present invention with portions cut away for clarity, showing the internal three (3) sequentially filled air chambers which are interconnected with a pressure resistive valve that requires a minimum pressure to build up within an inner air filled chamber before allowing air to pass into the subsequent air filled chamber, and showing a membrane panel for releasing any over-pressure;

FIG. 4 is a side cross-sectional view of the deep vein thrombosis prevention garment of the present invention as taken along line 4-4 of FIG. 3, showing the relative layered positions of the three (3) sequential air filled chambers when the deep vein thrombosis prevention garment is in the un-inflated configuration, and the positioning of the pressure resistive valves between each air filled chamber such that when a predetermined minimum pressure builds up within an inner air filled chamber, the pressure resistive valve will allow air to pass into the subsequent air filled chamber until each chamber is filled.

FIG. 5 is a side cross-sectional view of the deep vein thrombosis prevention garment of the present invention as taken along line 4-4 of FIG. 3, showing the relative positions of the three (3) sequential air filled chambers when the deep vein thrombosis prevention garment is in the inflated configuration, and directional arrows depicting typical airflow from the flexible air supply tube to the inner air filled chamber, through the pressure resistive valve to the second air filled chamber, through the pressure resistive valve to the third air filled chamber;

FIGS. 6-9 depict the deep vein thrombosis prevention garment of the present invention as used on the leg of a patient starting with an un-inflated configuration, and advancing through the inflation of each sequential air filled chamber;

FIG. 6 is an exemplary partial cross-sectional view of the deep vein thrombosis prevention garment of the present invention as used on the leg of the patient, showing the deep vein thrombosis prevention garment in a deflated configuration in which little or no pressure is exerted on the leg of the patient and blood flows unrestrictedly through the leg;

FIG. 7 is an exemplary partial cross-sectional view of the deep vein thrombosis prevention garment of the present invention as used on the leg of the patient, showing the deep vein thrombosis prevention garment in a partially inflated configuration with the inner air filled chamber filled with air to provide pressure on the leg of the patient to urge blood flow upward through the leg;

FIG. 8 is an exemplary partial cross-sectional view of the deep vein thrombosis prevention garment of the present invention as used on the leg of the patient, showing the deep vein thrombosis prevention garment in a partially inflated configuration with the inner air filled chamber filled with air to provide pressure on the leg and pass through the first pressure resistive valve to fill the second air filled chamber to provide additional pressure on the leg of the patient to urge blood flow further upward through the leg;

FIG. 9 is an exemplary partial cross-sectional view of the deep vein thrombosis prevention garment of the present invention as used on the leg of the patient, showing the deep vein thrombosis prevention garment in a fully inflated configuration with the inner air filled chamber filled with air to provide pressure on the leg and pass through the first pressure resistive valve to fill the second air filled chamber, and the second air filled chamber filled with air to provide additional pressure on the leg and pass through the second pressure resistive valve to fill the third air filled chamber to provide yet additional pressure on the leg of the patient to urge blood flow further upward through the leg;

FIG. 10 is a graphical representation of the air pressure supplied from the pump to the deep vein thrombosis prevention garment of the present invention, showing a maximum air pressure to be delivered, and the sequential pressure within each of the air filled chambers during a sequential inflation cycle before pressure supplied from the pump is released and all air filled chambers deflate;

FIG. 11 is a top plan view of the pressure resistive valve of the deep vein thrombosis prevention garment of the present invention, showing the chamber wall with the pressure resistive valve having a base which includes a pressure sensitive valve that is surrounded by a circular spacer formed with gaps in order to make sure that air can pass from air filled chamber to air filled chamber without the exit of the pressure resistive valve becoming blocked; and

FIG. 12 is a side view of the pressure resistive valve of the deep vein thrombosis prevention garment of the present invention, showing the chamber wall with the pressure resistive valve having a base which includes a pressure sensitive valve that is surrounded by a circular spacer formed with gaps in order to make sure that air can pass from air filled chamber to air filled chamber without the exit of the pressure resistive valve becoming blocked, and a typical air flow through the pressure resistive valve when a minimum desired pressure differential across the valve exists.

### DETAILED DESCRIPTION OF A PREFERRED EMBODIMENT

Referring initially to FIG. 1, FIG. 1 is a top plan view of the deep vein thrombosis prevention garment of the present invention generally designated 100. Garment 100 includes a central panel 102, a left side panel 104, and a right side panel 106. Garment panels 102, 104, and 106 are flexible and formed with an inside layer 105, an outside layer 103, and a perimeter binding 107 stitching the inside layer 105 and the outside layer 103 together. In a preferred embodiment, the inside layer 105 and the outside layer 103 of the deep vein thrombosis prevention garment 100 are made from durable cloth or other non-woven material that can comfortably contact a patient's skin.

A flexible air supply tube 108 enters central panel 102 and leads to a series of sequentially filled inner 110, intermediate 112, and outer 114 air chambers (shown in dashed lines). This flexible air supply tube 108 is shown having a non-descript length. It is to be appreciated that the length of the flexible air supply tube 108 may vary depending on the particular field of use, and the setting. For instance, in a hospital surgery setting, it may be difficult to position an air source immediately adjacent to the patient, and an extended air supply tube 108 is required.

Air is supplied to the flexible air supply tube 108 from a pump 140. In a preferred embodiment, pump 140 includes a compressor capable of providing a predetermined maximum air pressure force to fill the sequentially filled inner 110, intermediate 112, and outer 114 air chambers. As will be described in greater detail below, pump 140 can provide air at a predetermined pressure for a predetermined period of time, providing for an inflation and deflation cycle according to the desired therapy parameters.

As shown in FIG. 1, right side panel 106 is formed with a number of attachment straps 124, 126, and 128, with each strap having an integral fastener 130, 132, and 134, respectively, in a preferred embodiment, straps 124, 126, and 128 are provided with a hook-and-loop style fastener 130, 132, and 134. These hook-and-loop fasteners cooperate with the outside layer 103 of panels 102 and 104 to allow the deep vein thrombosis prevention garment 100 of the present invention to be positioned about a patient's limb and secured in place by wrapping the panels 102, 104 and 106 around the limb and firmly pressing the fasteners 130, 132, and 134 on straps 124, 126, and 128 against the outside layer 103. The hook-and-loop fasteners are attached to the outside layer 103 to hold the straps 124, 126, and 128 in place. This type of fastener and method of attachment of the deep vein thrombosis prevention garment 100 provide a deep vein thrombosis prevention garment 100 for patients having limbs of different sizes and can accommodate large or small diameter limbs simply by wrapping the panels 102, 104 and 106 around the limb and securing straps 124, 126, and 128 in place.

While the deep vein thrombosis prevention garment of the present invention in a preferred embodiment is manufactured having a hook-and-loop type fastener 130, 132, and 134, it is to be appreciated that any other types of fastener known in the art may be used without departing from the present invention.

Referring now to FIG. 2, the deep vein thrombosis prevention garment 100 of the present invention is shown being used by a patient 50 for the prevention of deep vein thrombosis. Specifically, as shown, the deep vein thrombosis prevention garment 100 is positioned around the lower leg 52, or calf, of patient 50, in communication with pump 140 through flexible air supply tube 108. Pump 140 supplies pressurized air through flexible air supply tube 108 to pressurize the sequentially filled inner 110, intermediate 112, and outer 114 air chambers (shown in FIG. 1).

FIG. 2 depicts a patient 50 in a sitting position and this shows merely an exemplary use of the deep vein thrombosis prevention garment 100 of the present invention. Indeed, the deep vein thrombosis prevention garment 100 of the present invention may be used with patients virtually in any position. As will be described in greater detail below, the inflation and deflation cycle of the sequentially filled air chambers 110, 112, and 114 may vary depending on the particular patient, and the particular environment. For instance, a patient using the deep vein thrombosis prevention garment of the present invention in a sifting position may opt for a faster inflation and deflation cycle, and may utilize higher air pressures in the sequentially filled air chambers 110, 112, 114 (shown in FIG. 1) than a patient using the deep vein thrombosis prevention garment in a supine position on an operating table.

It is also to be appreciated that while FIG. 2 depicts a patient 50 having one deep vein thrombosis prevention garment 100 on a leg 52, a number of deep vein thrombosis prevention garments may be used simultaneously. For instance, in a surgery setting, it is commonplace to utilize the deep vein thrombosis prevention garment 100 of the present invention on both legs.

As shown in FIG. 2, the deep vein thrombosis prevention garment 100 is positioned around the calf 52 of a patient 50 by positioning panels 102 and 104 (shown in FIG. 1) against the patient's leg, wrapping straps 124, 126, and 128 around the calf 52, and then securing the straps to the outside layer 103 (shown in FIG. 1) of panel 102 and 104 with fasteners 130, 132, and 134 (shown in FIG. 1).

Referring now to FIG. 3, a top plan view of the deep vein thrombosis prevention garment 100 of the present invention is shown with portions of the central panel 102 out away for clarity. The internal three (3) sequentially filled air chambers 110, 112, and 114 are easily shown from this view.

Inner air filled chamber 110 receives a pressurized air source through the flexible air supply tube 108 and fills with air, thereby expanding the inner air filled chamber 110. As the air pressure reaches a predetermined minimum level, a pressure resistive valve 116 allows air from the inner air filled chamber 110 to pass through the valve 116 into the sequentially filled intermediate air chamber 112. As air continues to be provided into the inner air filled chamber 110, through the flexible air supply tube 108, the pressure remains in excess of the predetermined minimum level for pressure resistive valve 116, and thus air continues to flow into the sequentially filled intermediate air chamber 112 that is equipped with a second pressure resistive valve 118 leading from the intermediate air filled chamber 112 to the sequentially filled outer air chamber 114. When intermediate air filled chamber 112 becomes pressurized in excess of a predetermined minimum level, pressure resistive valve 118 allows air from intermediate air filled chamber 112 to pass through the pressure resistive valve 118 into sequentially filled outer air chamber 114.

As sequentially filled inner 110, intermediate 112, and outer 114 air chambers are continued to be provided with pressurized air from the flexible air supply tube 108 and pump 140, the pressure in each chamber will continue to rise until the chamber pressures equalize with the pressure of the air from pump 140. In a preferred embodiment of the deep vein thrombosis prevention garment of the present invention, outer air filled chamber 114 may be provided with a membrane panel 120 for releasing any over-pressure. Specifically, membrane panel 120 is a non-woven material that provides resistance to the flow of air through the membrane. When the pressure within outer air filled chamber 114 exceeds a maximum value, air passes through membrane 120 to release the excess pressure thereby preventing excessive air pressure within chambers 110, 112, and 114.

In a preferred embodiment, the pressure resistive valves 116 and 118 are designed to remain dosed until the pressure within the inner air filled chamber reaches a predetermined minimum. In a preferred embodiment, the predetermined minimum may be the same for valve 116 and 118, or it may be different. For instance, in a preferred embodiment, the predetermined minimum for pressure resistive valve 116 may be 35 mmHg, and the predetermined minimum for pressure resistive valve 118 may be 25 mmHg.

As shown in FIG. 3, the sequentially filled inner 110, intermediate 112 and outer 114 air chambers are formed from a durable plastic sheeting 121 that is flexible and durable, and capable of withstanding prolonged periods of inflation and deflation without damage. In a preferred embodiment, sheeting 121 is polyvinyl chloride (PVC), but other materials known in the art may be used.

One benefit of using sheeting 121 is the ability to create seals, such as seals 122 to form the individual chambers 110, 112, and 114. These seals may be made by sonic welding, heat sealing, or any other method known in the art. It is important to note that chambers 110, 112 and 114 are formed using a total of four (4) sheets 111, 113, 115, and 121 (as will be shown in greater detail below in conjunction with FIGS. 4 and 5), with sheets 111, 113, and 115 being formed from the same material as sheet 121. The seals 122, 125, 127, and 129 provide for air-tight seals between the four (4) sheets 111, 113, 115, and 121 and allow for the pressurization of the resulting chambers.

While the deep vein thrombosis prevention garment 100 of the present invention is shown to be configured with three (3) air filled chambers 110, 112, and 114, it is to be appreciated that the deep vein thrombosis prevention garment 100 of the present invention may be made having additional sequentially filled air chambers. These additional sequentially filled air chambers function like the inner 110, intermediate 112, and outer 114 chambers and would fill in sequence.

Referring now to FIG. 4, a side cross-sectional view of the deep vein thrombosis prevention garment 100 of the present invention as taken along line 4-4 of FIG. 3 is shown. From this cross-sectional view, the relative positions of the sequential air filled inner 110, intermediate 112 and outer 114 chambers when the deep vein thrombosis prevention garment is in the un-inflated configuration are shown. Specifically, from this view, it can be easily seen that each sequentially filled air chamber overlies the previously filled air chamber. For instance, sequentially filled inner air chamber 110, located at the distal end of the deep vein thrombosis prevention garment, is overlapped by sequentially filled intermediate air chamber 112, which in turn is overlapped by sequentially filled outer air chamber 114.

From FIG. 4, four (4) sheets 121, 111. 113, 115, which form the sequentially filled inner 110, intermediate 112, and outer 114 air chambers, can be seen. Specifically, sheet 121 is a common backing to each of the air filled chambers. Sheet 111 is sealed to sheet 121 at seals 122 and 125 to form inner air filled chamber 110. A sheet 113 is positioned above the sheet 111 and is sealed to sheet 121 at seals 122 and 127 to form intermediate air filled chamber 112. And a sheet 115 is positioned above the sheet 113 and is sealed to sheet 121 at seals 122 and 129 to form outer air filled chamber 114. These seals are flexible and provide for the expansion of each air filled chamber 110, 112 and 114 as they inflate. Further, the positioning of the pressure resistive valves 116 and 118 between the inner 110 and intermediate 112 air filled chambers, and the intermediate 112 and outer 114 air filled chambers, respectively, allows air to pass into the subsequent air filled chamber even though the deep vein thrombosis prevention garment 100 is substantially flat when positioned on a patient 50.

As shown in FIG. 4, deep vein thrombosis prevention garment 100, when in its deflated configuration, is substantially fiat allowing a secure placement of the device around a limb 52 (shown in FIGS. 2, 6-9) of a patient. In the deflated configuration, the panels 102 and 104 are snugly wrapped around the limb 52, and the straps 124, 126 and 128 (shown in FIGS. 1-3) are secured to the outside of panel 104.

Referring to FIG. 5, another side cross-sectional view of the deep vein thrombosis prevention garment 100 of the present invention as taken along line 4-4 of FIG. 3 is shown. This Figure depicts the deep vein thrombosis prevention garment 100 in a fully inflated configuration. For clarity, FIG. 5 includes a number of directional arrows depicting typical airflow from the flexible air supply tube 108 to the inner air filled chamber 110, through the pressure resistive valve 116 to the intermediate air filled chamber 112, through the pressure resistive valve 118 to the outer air filled chamber 114.

Referring now to FIGS. 6 through 9, the deep vein thrombosis prevention garment 100 of the present invention is shown as used on the leg 52 of a patient 50 starting with an un-inflated configuration in FIG. 6, and advancing through the inflation of each sequential air filled chamber in FIG. 9.

Starting with FIG. 6, an exemplary partial cross-sectional view of the deep vein thrombosis prevention garment 100 of the present invention, as used on the leg 52 of the patient (shown in FIG. 2), showing the deep vein thrombosis prevention garment 100 in a deflated configuration, is depicted. In the deflated configuration, little or no pressure is exerted on the leg 52 of the patient and blood flows unrestrictedly through the leg. As depicted in FIG. 7, as air is introduced into the flexible air supply tube 108 and begins to fill sequentially filled inner air chamber 110, air pressure is introduced distally to the leg 52 to urge blood within the leg flow upward in a distal-to-proximal direction 150.

As air is continually introduced into inner air filled chamber 110, a minimum pressure is reached in inner air filled chamber 110 and pressure resistive valve 116 allows air to flow from inner air filled chamber 110 to intermediate air filled chamber 112. As intermediate air filled chamber 112 inflates, as depicted in FIG. 8, it provides additional pressure on the leg 52 of the patient 50 to urge blood flow further upward through the leg in direction 150.

As air is continually introduced into inner air filled chamber 110, the air flows from inner air filled chamber 110 into intermediate air filled chamber 112. When a minimum pressure is reached in intermediate air filled chamber 112, pressure resistive valve 118 allows air to flow from intermediate air filled chamber 112 to outer air filled chamber 114, as shown in FIG. 9. As outer air filled chamber 114 inflates, it provides yet additional distal-to-proximal pressure on the leg 52 of the patient to urge blood flow further upward through the leg in direction 150.

When a single inflation cycle is completed, the air pump 140 (shown in FIGS. 1-2) releases the air pressure to the flexible air supply tube 108 (shown in FIGS. 1-5), and the air dissipates through tube 108 and through pressure membrane 120 (shown in FIG. 3), to return the deep vein thrombosis prevention garment 100 of the present invention to its originally deflated state as shown in FIG. 5. This cycle is repeated according to a particular patient profile, and may be repeated for extended periods of time in order to reduce the likelihood that thrombosis will develop in the patient.

Referring now to FIG. 10, a graphical representation of the air pressure supplied from the pump to the deep vein thrombosis prevention garment of the present invention is shown and generally referred to as 200. Graph 200 includes a vertical Air Pressure axis 202 and a horizontal Time axis 204. This graph 200 depicts a typical inflation and deflation cycle that occurs in the deep vein thrombosis prevention garment of the present invention.

Graph 200 includes a primary supply air pressure curve 206 which corresponds to the air provided by pump 140 (shown in FIGS. 1-2) to flexible air supply tube 108 (shown in FIGS. 1-9). This air supply begins at the start of the inflation cycle and rises to a maximum supplied air pressure 208. This maximum supplied air pressure 208 is approximately equal to an overall maximum pressure 220 (shown by dashed line) that corresponds to the maximum desired pressure within the sequentially filled air chambers 110, 112, and 114 (shown in FIGS. 1 and 3-9), the maximum pressure medically safe, or any other maximum value utilized in the art to ensure safe operation of the deep vein thrombosis prevention garment 100.

As the pressure within the flexible air supply tube 108 is supplied to inner air filled chamber 110, the pressure 210 within inner air filled chamber 110 begins to increase. As inner air filled chamber 110 begins to reach capacity, the pressure within the chamber passes the minimum pressure (depicted as value 224), to activate the pressure resistive valve 116 (shown in FIGS. 3-9). At that time 212, the air begins to pass through the pressure resistive valve 116 into intermediate air filled chamber 112.

The maximum air pressure 208 is maintained and as the air continues to pass into inner air filled chamber 110, through pressure resistive valve 116 and into intermediate air filled chamber 112, the air pressure 214 in intermediate air filled chamber 112 rises. As intermediate air filled chamber 112 begins to reach its maximum capacity, the pressure within the intermediate air filled chamber 112 passes the minimum pressure (again depicted as value 224), to activate the pressure resistive valve 118 (shown in FIGS. 3-9). At that time 216, the air begins to pass through the pressure resistive valve 118 into outer air filled chamber 114.

The inflation cycle is completed once the three (3) chambers 110, 112, and 114 have had sufficient time to inflate. Following the inflation cycle, the deflation cycle begins at time 218 and the pressure 222 in the flexible air supply tube 108 decreases to zero. It is also contemplated that along with the decrease in the pressure 222 of the flexible air supply tube 108, the pressures 210, 214 and 217 likewise return to zero in substantially the same time. Once this inflation and deflation cycle is completed, a delay may be inserted prior to beginning of the next inflation and deflation cycle.

Using the deep vein thrombosis prevention garment 100 of the present invention, the time for a complete inflation cycle, deflation cycle and delay is approximately twenty (20) seconds. As a result, the deep vein thrombosis prevention garment 100 can be cycled three (3) times every minute in order to provide a continuous force to create the desired peristaltic effect. It is to be appreciated that the specific period for a complete cycle may be changed depending on the size of the limb being treated, the pressure desired, and the peristaltic forces necessary to minimize the likelihood of the development of a thrombosis.

The pressure 224 depicted in FIG. 10 has been shown to be the same for both pressure resistive valve 116 and pressure resistive valves 118. However, it is to be appreciated that the pressure resistive valves 118 may be different, and utilize different minimum air pressures. Indeed, in a preferred embodiment, pressure resistive valve 116 may have a minimum air pressure of 35 mmHg, while pressure resistive valve 118 may have a minimum air pressure of 25 mmHg. Other pressures may be utilized without departing from the present invention.

Referring now to FIG. 11, a top plan view of an exemplary pressure resistive valve 116 of the deep vein thrombosis prevention garment 100 of the present invention is shown. This valve 116 is shown attached to the chamber wall sheet 111 with the pressure resistive valve 116 having a base 250 which includes a pressure resistive membrane 258 that is surrounded by a circular spacer 252 formed with gaps 254 in order to make sure that air can pass from one air filled chamber to the next air filled chamber without the pressure resistive membrane 256 becoming blocked.

As shown from side view FIG. 12, the pressure resistive valve 116 of the deep vein thrombosis prevention garment 100 of the present invention shows the chamber wall sheet 111 with the pressure resistive valve 116 having a base 250 which includes a pressure resistive membrane 256 (shown in FIG. 11) that is surrounded by a circular spacer 252 formed with gaps 254 in order to make sure that air can pass through the pressure resistive valve 116 from an inner air filled chamber 110 in directions 260 and 262 to an intermediate air filled chamber in directions 264 and 266. In the event that the adjacent sheet 113 covers the exit of the pressure resistive valve 116, air will nevertheless pass through the gaps 254 when a minimum desired pressure differential across the valve exists.

While there have been shown what are presently considered to be preferred embodiments of the present invention, it will be apparent to those skilled in the art that various changes and modifications can be made herein without departing from the scope and spirit of the invention.

1. A deep vein thrombosis prevention garment, comprising:
a central panel having a plurality of sequentially filled air chambers receiving air from a flexible air supply tube in communication with one or more air chambers;
a left side panel extending from said central panel; and
a right side panel extending from said central panel opposite said left side panel; and
a means for fastening said left side panel to said right side panel.

2. The deep vein thrombosis prevention garment of claim 1, further comprising a pressure resistive valve positioned between each sequential air filled chamber and configured to pass air having a predetermined minimum pressure from an inner air filled chamber to an outer air filled chamber.

3. The deep vein thrombosis prevention garment of claim 2, further comprising said predetermined minimum pressure being in the range of 25 mmHg to 35 mmHg.

4. The deep vein thrombosis prevention garment of claim 1, further comprising said predetermined minimum pressure being 25 mmHg.

5. The deep vein thrombosis prevention garment of claim 1, further comprising a pump in communication with said flexible air supply tube to provide air having a predetermined pressure sufficient to inflate one or more sequentially filled air chambers.

6. The deep vein thrombosis prevention garment of claim 5, wherein said predetermined pressure is 35 mmHg.

7. The deep vein thrombosis prevention garment of claim 5, further comprising said pump configured to provide air at the predetermined pressure for a fixed period of time.

8. The deep vein thrombosis prevention garment of claim 1, further comprising a means for releasing air from said sequentially filled air chambers if said air exceeds a pressure of 35 mmHg.

9. The deep vein thrombosis prevention garment of claim 1, further comprising a means for pressurizing said inner air filled chamber to 35 mmHg.

10. A deep vein thrombosis prevention garment comprising:
a central panel formed with an inner air filled chamber in communication with an air supply tube, and in communication with the inlet of a first pressure resistive valve having an inlet and an outlet;
an intermediate air filled chamber in communication with said outlet of said first pressure resistive valve, said intermediate air filled chamber in communication with the inlet of a second pressure resistive valve having an inlet and an outlet;
an outer air filled chamber in communication with said outlet of said second pressure resistive valve, and formed with a pressure relief membrane, said membrane in communication with said outer air filled chamber and configured to pass air exceeding a predetermined pressure.

11. The deep vein thrombosis prevention garment of claim 10, further comprising wherein said first pressure resistive valve is configured to pass air having a pressure in the range of 25 mmHg to 35 mmHg.

12. The deep vein thrombosis prevention garment of claim 10, further comprising wherein said second pressure resistive valve is configured to pass air having a pressure of 25 mmHg.

13. The deep vein thrombosis prevention garment of claim 2, further comprising a membrane panel located on an outer sequentially air filled chamber and in communication with the ambient environment and configured to pass air when air pressure exceeds a maximum pressure value.

14. The deep vein thrombosis prevention garment of claim 10, wherein the pressure relief membrane is further configured to pass air to the ambient environment.
